(19) United States
(12) Patent Application Publication
(10) Pub. No.: US 2026/0191188 A1
(43) Pub. Date: Jul. 9, 2026

(54) FEEDING MOTION DUCK DECOY

(71) Applicant: Jahpoo Outdoors Ltd., Austin, TX (US)

(72) Inventors: Carson Ross Tharp, Austin, TX (US); Joseph William Conrad, Houston, TX (US)

(73) Assignee: Jahpoo Outdoors Ltd., Austin, TX (US)

(21) Appl. No.: 19/551,409

(22) Filed: Feb. 26, 2026

Related U.S. Application Data
(63) Continuation-in-part of application No. 18/429,409, filed on Jan. 31, 2024, now Pat. No. 12,588,673.
(60) Provisional application No. 63/442,725, filed on Feb. 1, 2023.
(60) Provisional application No. 63/789,362, filed on Apr. 15, 2025.

(51) Int. Cl. A01M 31/06

(52) U.S. Cl. CPC A01M 31/06

(57) ABSTRACT

A motion duck decoy, in which a duck decoy comprises a weight and a power source enclosed within the duck decoy, whereby powered motion of the weight within the duck decoy causes the duck decoy to mimic the feeding motion of a duck by changing the position of the decoy from a resting duck position to a duck feeding position and revealing one or more duck feet on the underside of the decoy.

The present application is a continuation-in-part of U.S. Non-Provisional Application No. 18/429,409, filed Jan. 31, 2024, which claims the priority of U.S. Provisional Application No. 63/442,725, filed Feb. 1, 2023. The present application also claims the priority of U.S. Provisional Application No. 63/789,362, filed Apr. 15, 2025. Each of the foregoing applications is hereby incorporated in its entirety.

### FIELD OF THE INVENTION

The invention is in the field of waterfowl decoys, specifically motion duck decoys.

### BACKGROUND

One of the most common and unique motions that a duck makes is a roughly 90-degree forward rotation to feed on the floor of ponds, lakes, and marshes. Ducks do this by rotating about their breasts, extending their heads deep into the water, and letting their tails stick straight into the air. In the sport of waterfowl hunting, there is a void in the market for a motion duck decoy that can reproduce this characteristic “tail up” duck feeding motion with lifelike “paddling” duck feet effortlessly and realistically.

Other solutions do not effectively or realistically mimic the natural and realistic feeding motion of living ducks. Other solutions do not create a disruption on the water surface. Other decoys do not reveal the characteristic “flash” that attracts the eye of other ducks passing high overhead. Other motion decoys do not incorporate moving feet with this kind of full body “tail up” motion. Other motion decoys use external components such as cables, wires, jig rigs, external weights and weight systems, motors, battery packs, bungee cords, electrical cords that are tedious, difficult and time-consuming to set up and can be ensnared in weeds, sticks and other water debris.

### SUMMARY

Embodiments of the invention relate to duck decoys, in particular to a motion duck decoy that mimics the feeding motion of a duck. Embodiments may include a duck decoy that rotates from a resting duck position to a duck feeding position and revealing or more duck feet.

Disclosed is an embodiment of a motion duck decoy, comprising a duck decoy comprising a weight and a power source enclosed within the duck decoy, whereby powered motion of the weight within the duck decoy causes the duck decoy to mimic the feeding motion of a duck. In the duck resting position, the decoy rests on a surface of the water with the duck head out of water, and in the duck feeding position, the duck head is submerged and the duck tail section is elevated above the surface of the water. Elevating the duck tail section above the surface of the water may reveal a light-colored area of the underside of the decoy. A motor may be enclosed within the decoy. The decoy shell may include an underside shell surface having a rounded shape that assists rotation of the duck decoy.

Also disclosed is an embodiment of a motion duck decoy comprising a duck decoy, and disposed within said duck decoy, a mechanical assembly and means for moving the assembly within the decoy to cause one or more duck feet to move in a paddling motion to further mimic the feeding motion of a duck. In an embodiment, the mechanical assembly is powered by a motor. The mechanical assembly may be powered by the same motor that drives powered motion of the weight within the decoy.

Also disclosed is a motion decoy comprising a decoy body, a movable mass disposed within the decoy body, and a drive system including a motor and a drive coupling configured to impart movement to the movable mass along a defined path within the decoy body, wherein movement of the movable mass alters a center of gravity of the decoy body to produce lifelike motion of the motion decoy. The drive coupling may include a flexible drive element. The movable mass may not be attached or fixed to the drive coupling.

### DRAWINGS

FIG. 1 illustrates the assembled shell of an exemplary motion duck decoy.

FIG. 2 illustrates the internal assembly mounted inside a shell section of an exemplary motion duck decoy.

FIG. 3 illustrates one perspective of the internal assembly of an exemplary motion duck decoy.

FIG. 4 illustrates an alternative perspective of an internal assembly of an exemplary motion duck decoy.

FIG. 5 illustrates an illustrates an alternative perspective of an internal assembly of an exemplary motion duck decoy.

FIG. 6 illustrates a component of an internal assembly of an exemplary motion duck decoy.

FIGS. 7A, 7B, and 7C illustrate different perspectives of an alternative embodiment of an internal assembly of an exemplary motion duck decoy.

FIGS. 8A, 8B, and 8C illustrate different perspectives of an alternative embodiment of an internal assembly of an exemplary motion duck decoy.

FIGS. 9A, 9B, and 9C illustrate different perspectives of an alternative embodiment of an internal assembly of an exemplary motion duck decoy.

FIGS. 10A and 10B illustrate different perspectives of an alternative embodiment of an internal assembly of an exemplary motion duck decoy.

FIGS. 11A and 11B illustrate different perspectives of an alternative embodiment of an internal assembly of an exemplary motion duck decoy.

FIGS. 12A, 12B, and 12C illustrate different perspectives of an alternative embodiment of an internal assembly of an exemplary motion duck decoy.

FIG. 13 is a bottom perspective of an embodiment of a shell of an embodiment of a motion duck decoy.

FIGS. 14A and 14B illustrate alternative perspectives of an embodiment of an exemplary motion duck decoy with padding duck fees. FIG. 14A illustrates an underside view of the decoy; FIG. 14B shows a side sectional view showing an exemplary internal assembly.

FIGS. 15A and 15B illustrate alternative perspectives of an alternative embodiment of an exemplary motion duck decoy with paddling duck feet. FIG. 15A shows a side sectional view showing an exemplary internal assembly. FIG. 15B illustrates the decoy in an exemplary feeding position relative to a water surface including a side section view showing an alternative embodiment of an exemplary internal assembly.

FIGS. 16A and 16B illustrate alternative perspectives of an internal assembly of an alternative embodiment of an exemplary motion duck decoy. FIG. 16A shows a side sectional view from an upper perspective relative to the body of the decoy. FIG. 16B shows a side sectional view from a lower perspective relative to the body of the decoy.

### DETAILED DESCRIPTION

Embodiments of the invention relate to a waterfowl hunting decoy used to mimic the behavior of a feeding duck. The motion duck decoy may include a seamless shell shape and a wireless remote to control the on/off motion of the bird. The decoy may use a battery pack to power a motor or other mechanism that moves a weight to move the center of gravity of the decoy forward, thereby causing the forward part of the duck decoy to rotate into the water and mimic the feeding motion of a duck. The forward part of the decoy that rotates into the water may include the duck head, the neck, and/or breast sections of the decoy. The motion of the duck may be achieved via a Scotch yoke mechanism connected to a track with the weight. Electronic and mechanical components such as weight, Scotch yoke, batteries and motor may be wholly contained within the decoy.

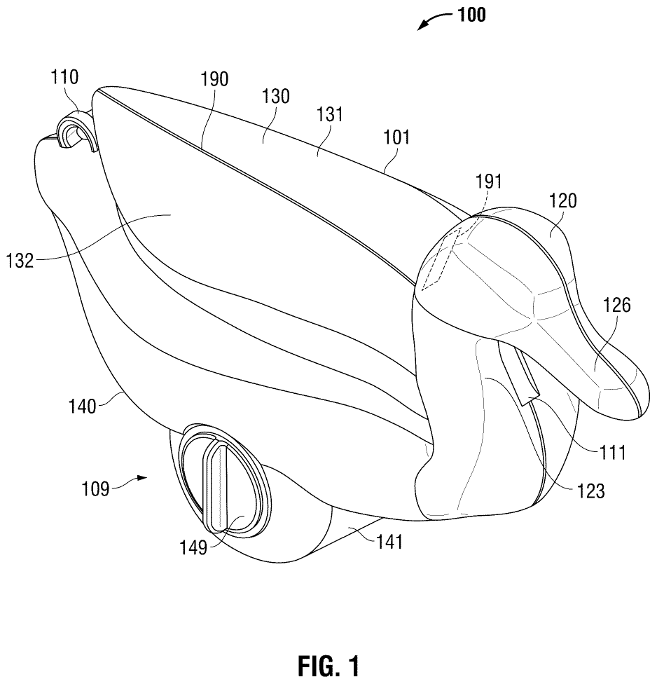

FIG. 1 shows an exemplary duck decoy 100 according to an embodiment of the invention. Decoy 100 has a shell 101 with top shell surface 130, bottom or underside shell surface 140, battery pack 109, battery compartment cap 149, tail feathers 110, and duck head 120.

The shell 101 of decoy 100 may be hollow and may house the mechanical and electrical components of the decoy. The shape of shell 101 may be designed to mimic the dynamic nature of a duck while maintaining a stable, buoyant, and waterproof vessel for the decoy's internal mechanical and electrical components. Natural duck markings may be painted, printed or etched on the top shell surface of the decoy to give it the realistic appearance of any different type of duck.

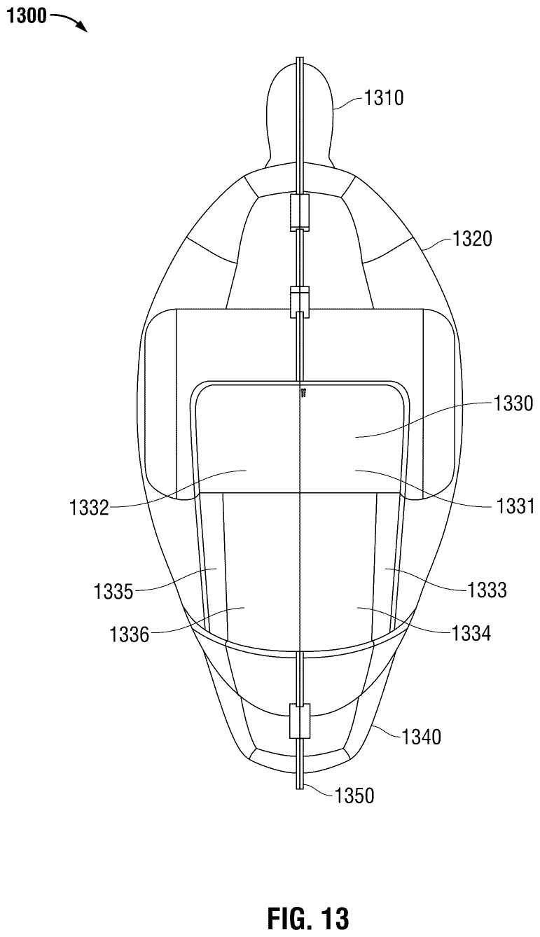

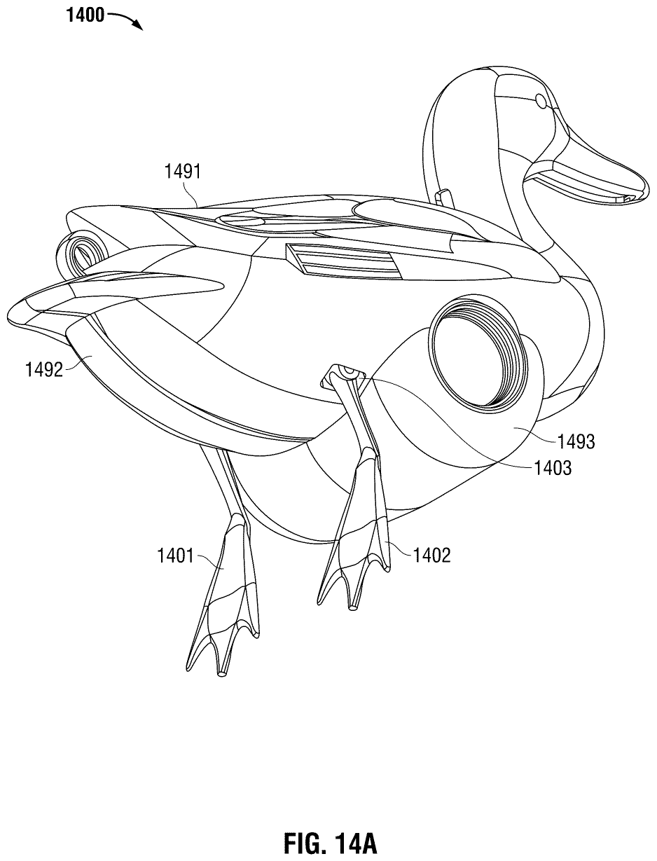

The bottom or underside shell surface may be colored white, or a lighter color that contrasts with the coloration and markings on the top shell surface, to reveal a visual “flash” when the decoy goes “tail-up” into the feeding position. FIG. 13 shows a bottom perspective of an embodiment of a shell (1300) of an exemplary duck decoy including duck head section (1310), duck tail section (1340), loop (1350), and underside (1320). Underside 1320 includes white or light-colored section 1330. In an embodiment white or light-colored section 1330 may include one or more white or light-colored panels or areas (1331, 1332, 1333, 1334, 1335, 1336). The flash may catch the eyes of ducks or waterfowl as they fly over the decoy. The flash also improves visibility (relative to static decoys, for example) to ducks passing overhead a significant distance away from the decoy, for example, at an altitude in excess of 4,000 feet.

The bottom shell surface 140 of shell 101 may be flat, substantially flat, or substantially planar. The bottom or underside shell surface 140 may include a rounded shape or protrusion or shape 141 to assist body rotation. Rounded shape 141 may take the form of a half cylinder. Rounded shape 141 may be located in or towards the forward section of the decoy to assist body rotation. The duck head 120 of the decoy includes an internal cavity (not shown in FIG. 1). A water port 111 may be located on the forward side of neck 123 and an air port 191 may be located on the aft side of neck 123.

In an embodiment, the air port 191, water port 111, and the internal cavity of the shell (not shown) improve buoyancy of the decoy. As the forward part of the decoy arcs into the water in the beginning of a feeding cycle, water flows into the cavity through water port 111 and air exits the cavity through air port 191, and the water in the cavity helps the duck head remain submerged during the feeding cycle. As the duck head exits the water at the end of the feeding cycle the water flows out through water port 111 and air port 191. In embodiments, there may be two or more water ports, for example one in the neck and one in the underside of beak 126; and a water port may extend from the neck to the underside of beak 126.

Shell 101 may be manufactured in two shell sections 131, 132. In an embodiment, shell sections 131, 132 may correspond to port and starboard halves of the decoy that join along a longitudinal line 190 that runs down the center of shell upper or top surface 130 and shell bottom surface 140. In alternative embodiments, shell 101 may be manufactured in two, three or more sections that join at various positions, areas, locations or along different lines corresponding to the geometry of the shell sections. Shell sections 131 and 132 may be joined or fastened together by a silicon adhesive or other waterproof adhesive seal. Other bonding means may be used to join or fasten together the two halves, including for example ultrasonic welding, hot plate welding, or laser welding.

Shell 101 may include an opening allowing for access into battery compartment (not shown in FIG. 1). A waterproof or watertight threaded cap 149, which may be circular, may provide access to the battery compartment from the exterior of shell 101.

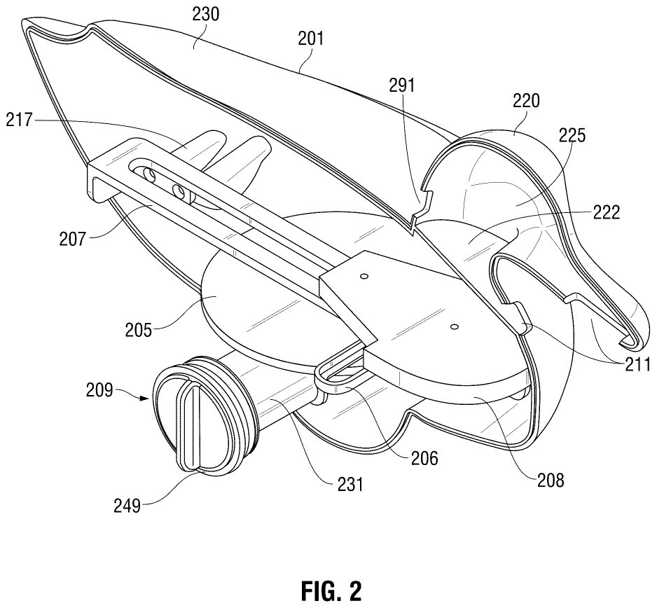

FIG. 2 shows an exemplary duck decoy shell section 201 according to an embodiment of the invention. Decoy shell section 201 includes shell interior 214 and duck head 220. Duck head 220 may include water cavity 225, cavity floor 222, and air port notch 291 and water port notches 211. Shell interior 214 may include internal electrical and mechanical components track 207, weight 208, wheel (or disk-shaped crank) 205, sliding yoke 206, battery pack 209, battery compartment 231, and waterproof or watertight threaded cap 249. Cap 249 may be used to create a watertight seal between the cap and the shell. Cap 249 may use a rubber or silicon ring or O-ring that is compressed or squeezed between the cap and the shell. The watertight seal formed by the cap may be used to protect the battery pack, internal and electrical assembly from exposure to water. The battery pack may be placed into or mounted on a battery mount that is fastened or connects to the shell mounted via threaded screws. The battery mount may house the battery pack and/or battery snap connector. The battery pack may be rechargeable, for example via a USB port; the battery pack may be removable or fixed inside the decoy. Shell interior 214 may include threaded supports or holes 217 for the mounting of the aft end of yoke 207. Shell interior 214 also may include threaded supports or holes (not shown) for mounting the forward end of yoke 207.

Cavity floor 222 may be substantially planar and may substantially follows the surface of shell upper or top surface 230. In an embodiment, cavity floor 222 prevents water in cavity 225 from entering shell interior 214 where the electrical components are located. In an embodiment, the volumetric size of cavity 225 may affect the arcing motion. Use of creative shell design with the location and orientation of cavity floor 222 may improve the performance of the decoy. If the duck head does not submerge completely, the cavity may be increased in size to hold more water. If the duck head over-arcs, the size of the cavity can be reduced. The location of cavity floor 222 may be elevated to reduce the volume of cavity 225 or lowered to increase the volume of cavity 225.

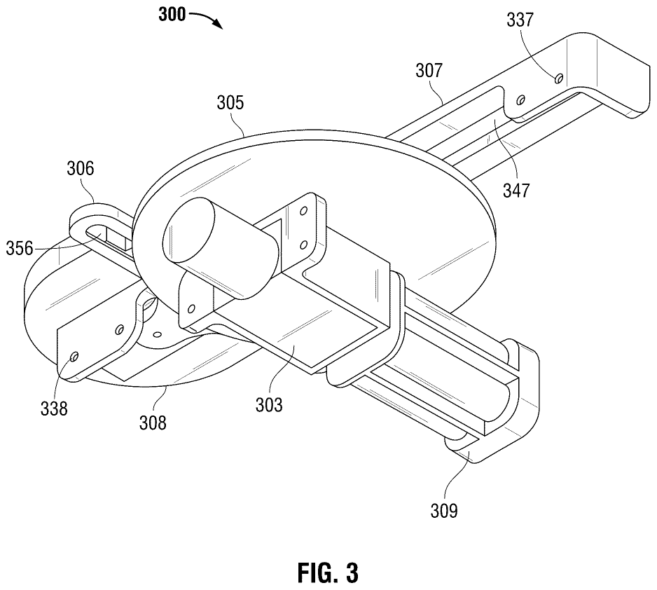

FIG. 3 illustrates one perspective of an exemplary internal assembly 300 of an exemplary duck decoy according to an embodiment of the invention. Shown in FIG. 3 are track 307 with track slot (or slit) 347, wheel 305, sliding yoke 306 and yoke slot (or slit) 356, weight 308, motor 303, and battery pack 309. Track 307 may include threaded holes 337, 338 for mounting or fastening track 307 to threaded supports or holes in the interior of the decoy.

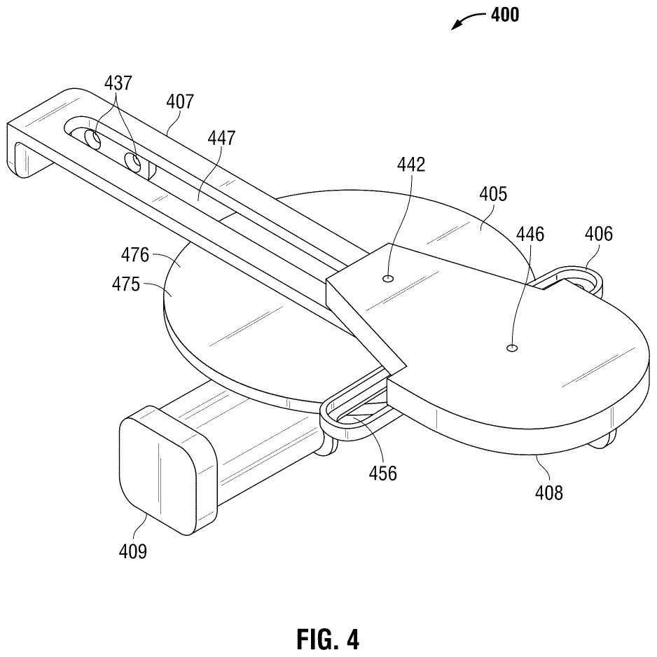

FIG. 4 illustrates an alternative perspective of an exemplary internal assembly 400 of an exemplary duck decoy according to an embodiment of the invention. Shown in FIG. 4 are track 407 with track slot 447, threaded hole 437, wheel 405, sliding yoke 406 and yoke slot (or slit) 456, weight 408, screws 442, 446 for mounting weight 408 to sliding yoke 406, and battery pack 409.

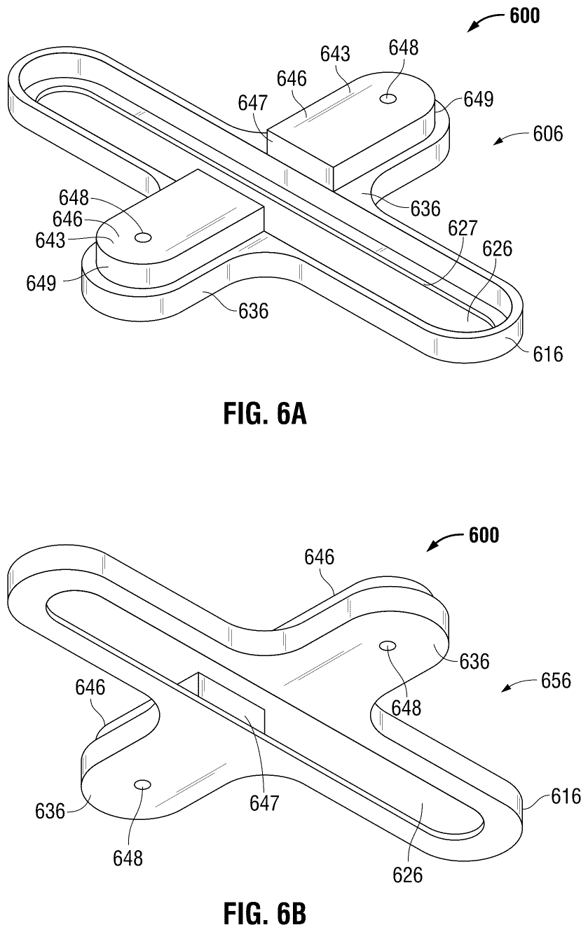

FIG. 6A illustrates a perspective (606) from above, and FIG. 6B illustrates a perspective (656) from below, of an exemplary sliding yoke 600 according to an embodiment of the invention. Sliding yoke 600 may include body 616, slot 626, flanges 636, and slider blocks 646 mounted to flanges 636. In an embodiment each slide block 646 may include a planar foot 647 and rounded head 649. Rounded head 649 may include a threaded hole 648 for fastening sliding yoke 600 to the weight (not shown). In an embodiment, planar foot 647 may be flush with inner planar surface 627 of slot 626.

As illustrated in FIGS. 4 and 6, weight 408 may be fastened to sliding yoke 406, 600 via screws 442, 446 screwed or threaded into screw holes 648 in slide blocks 646. In an embodiment, weight 408 may be mounted flush against upper surfaces 643 of slide blocks 646. Weight 408 may be specifically designed to fit inside of the shell. The forward shape of weight 408 may conform to the shape of the forward end of the interior of the shell. In an embodiment, the shape of the weight may ensure that more than half the mass of weight 408 is in the forward half of weight 408 as it is installed in the decoy. The shape of the weight may be designed to allow for the center of mass to be in the center of the decoy above the motor and battery compartment when the decoy is in the resting position. When the weight is moved forward within the decoy towards the bow or head of the decoy, may shift the center of mass of the decoy forward of the center of mass of the decoy in its resting position. The weight may be moved to the most forward position within the decoy permitted by the geometry of the shell and the shell and other internal components. The weight may be moved to a position forward of the center of gravity of the decoy in its resting position. The shifting of the center of mass of the decoy forward with the weight forces the body of the decoy to rotate, the duck head to arc into the feeding position, the tail of the decoy to rise, and the underside of the decoy to “flash.”

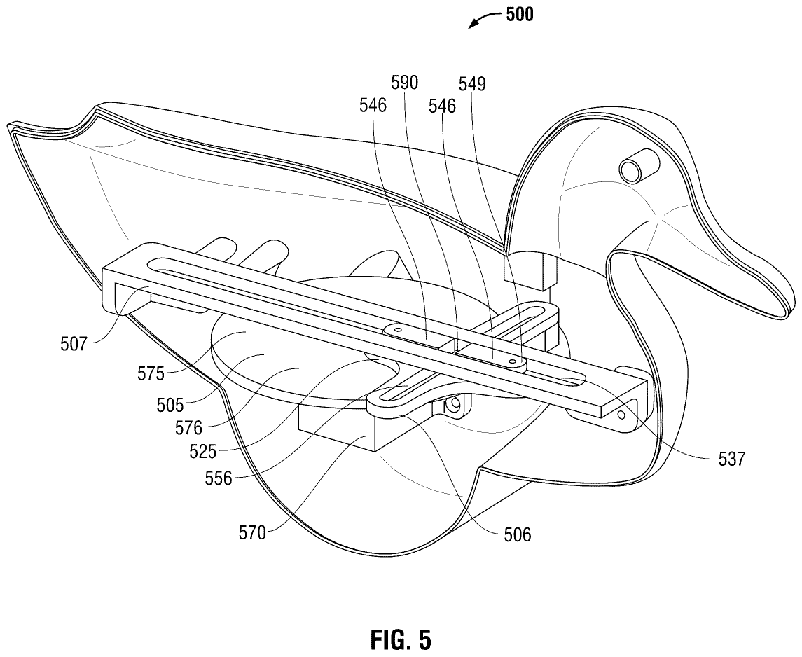

FIG. 5 illustrates how sliding yoke 506, track 507, and wheel 505 may work together according to an embodiment of the invention. Slide blocks 546 of sliding yoke 506 fit within and slide linearly within track slot 537 of track 507 inside decoy shell 500. In an embodiment, the rounded heads 549 of slide blocks 546 minimize friction as slide blocks 546 move linearly in track 507. As sliding yoke 506 moves linearly along track 507, it passes above and substantially parallel to the upper surface of wheel 505. There may be a gap 525 between the upper surface of wheel 505 and lower surface of sliding yoke 506 to avoid friction between wheel 505 and sliding yoke 506. Wheel 505 may include an upwardly-extending pin (not shown) that extends through gap 525 and into yoke slot 556 to engage sliding yoke 506. In the fully-forward configuration of weight 505 shown in FIG. 5, the pin may be located under gap 590 between slider blocks 546.

As shown in FIGS. 4 and 5, the sliding yoke 406, 506 and weight 408 assembly move longitudinally along track 407, 507, a static element of the slider-crank assembly. To minimize friction as slide blocks (546) slide though the track (507, 407), the track and slide blocks may be constructed of plastic or other low-friction material. In an embodiment, track slot (or slit) 447 may extend approximately the length of track 407, or approximately half the circumference of the wheel. Track 407 may be mounted to the shell via screws that thread into the shell body at the front and rear.

The sliding yoke (or Scotch yoke) (406, 506) is a dynamic component of the slider-crank assembly that may be sit or be mounted above wheel (405, 505) and below slide (407, 507). An upward-extending pin (not shown) may be mounted, fixed or located on the edge or outer rim (475, 575) of the wheel. The rotational movement of the pin drives the movement of the sliding yoke and weight within the decoy. As the wheel rotates, the pin moves transversely within sliding yoke slot (456, 556) and drives sliding yoke (406, 506) longitudinally through the decoy along track (407, 507). The sliding yoke translates the rotational motion of the wheel to a linear longitudinal motion of the weight within the decoy shell. Wheel (405, 505), which may be a dynamic component of the assembly, may be mounted in the center of the decoy such that the upper surface of the wheel is below and substantially parallel to track (407, 507) and sliding yoke (406, 506). In an embodiment, the wheel may be mounted above the motor. In an embodiment, the center of gravity of the decoy in the resting position may be located above the center of the wheel. The wheel may be mounted to the motor shaft (not shown) of motor (570). The motor shaft may be a round shaft with a flat edge (or fit key) for securely holding and rotating the wheel. An upwardly extending pin may or located or mounted on the edge or rim (475, 575) and upper edge (476, 576) of the wheel and may fit inside the slot of the sliding yoke. As the motor rotates the wheel, the pin moves in a circular motion around the center of the wheel and transversely within the sliding yoke.

In an embodiment, motor 570 may be a 6-volt worm gear motor mounted internally of the decoy shell. Motor 570 may rotate wheel (505) at a preset rotation per minute. The motor can be sourced through multiple retail such as Amazon, Alibaba, RC Motor Retail Stores. In an embodiment, the wheel may rotate continuously or periodically through 360 degrees at a rate of 10-100RPM. In an embodiment the wheel may rotate at a rate of approximately 15-30 RPM.

In an embodiment, an electric or electronic transceiver or receiver (not shown) may be mounted inside the shell under the motor and slide. The transceiver or receiver may be used to control or actuate the internal motor in the decoy and control or actuate the feeding motion of the decoy. The transceiver or receiver may control a relay, transistor or similar component between the battery pack and motor. The receiver may connect to an external transmitter or transceiver (for example, a wireless remote) via radio, Bluetooth, or other wireless communication signal or network. The transmitter or transceiver may communicate with the receiver's on/off function. The transmitter or transceiver may have the capability to operate multiple receivers. The transmitter or transceiver may operate one or more receivers from up to 50-100 yards away. The transceiver or receiver may include a motor driver, switching logic, and radio circuitry, for example, Wireless Communication of RF 433 MHz OOK/ASK Modulation Radio. The receiver and transmitter (or transceivers) can be sourced from multiple outlets - RC Toy Retail shops, Alibaba, and Amazon. The receiver may have two 22-gauge wire with a female wire connector attached. The female wire connectors then pair with male end, one connected to the motor and the other connected to the battery snap connector.

In an embodiment, the motion duck decoy may include an anchor mount. The anchor mount (not shown) may have the shape of a major arc circle, protruding from the intersection of the half cylinder on the bottom shell surface of the decoy and the front of the decoy. with a thread hole on the shell's exterior. The anchor mount may be used to connect a decoy rig, which may include a lead weight, monofilament, and a stay-lock snap. A conventional decoy rig can be found at most hunting or outdoor sporting goods retail stores. The lead weight is intended to sit at the bottom of a body of water and hold the decoy in a specific location. The monofilament connects the lead weight to a stay-lock snap and the stay-lock snap connects directly to the thread hole on the shell exterior. A decoy rig can facilitate set up, retrieval, and storage of the decoy.

In embodiments, the plastic components of the decoy may be a mixture of 3D-printed, roto-mold, and injection-molded parts utilizing nylon, ABS or polyethylene (e.g., HDPE, LDPE) plastic. In an embodiment, the track, sliding yoke, wheel, battery compartment, and battery cap may be fabricated using a 3-D printer. In an embodiment, one or more of these components may be injection molded. The exterior shell components may be painted with non-toxic, environmentally safe paint. After the shell has been painted, the mechanical and electrical assemblies are mounted into the shell and the two shell halves are bonded together. The electrical components may be conventional off-the-shelf components, readily available through outlets such as amazon, Alibaba, and RC Retail stores. Alternative embodiments may be injection molded, roto molded, or 3-D printed. The assembly processes differ given different mechanical assemblies, electrical components and shell shape.

In an embodiment, the outer dimensions of the shell may be approximately 16″ long by 7″ wide. The height may be approximately 6″ to the upper surface of the shell and 9″ to the upper surface of the duck head. The outer dimensions of the shell may vary, and the dimensions may change depending on the type or species of duck the decoy is intended to mimic.

The weight, in an embodiment, may be made of lead, may be formed in a mold, and may weigh in the range of 200-800 grams, or more for a large decoy. In an embodiment the weight weighs 600-700 grams.

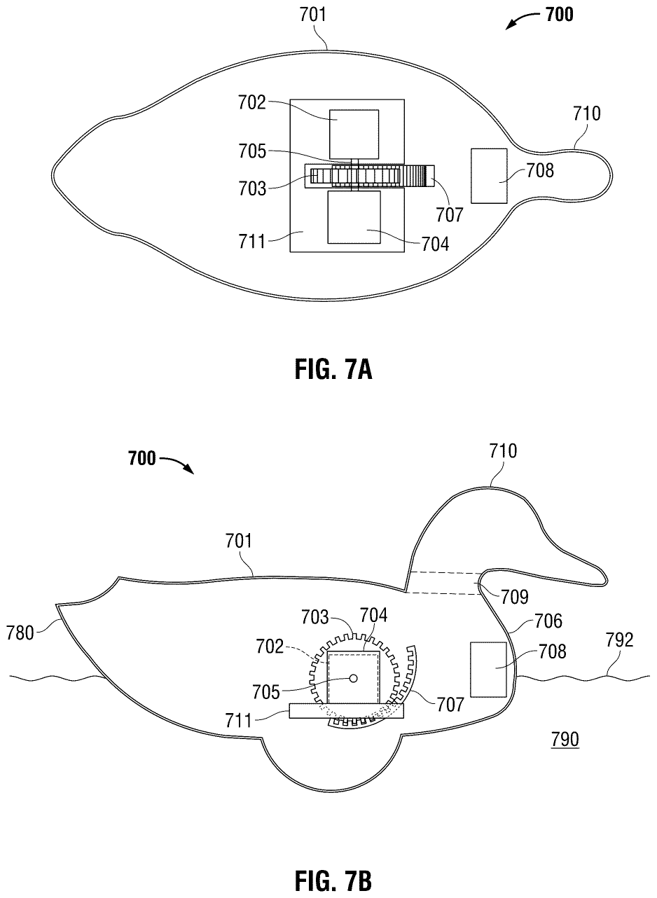

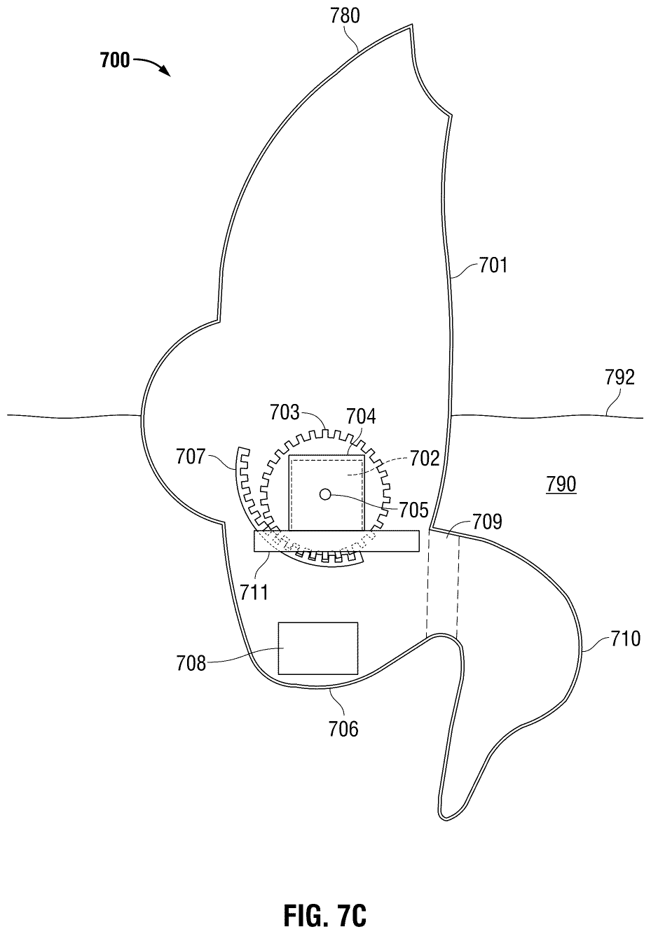

FIGS. 7A, 7B, and 7C illustrate different perspectives of an alternative embodiment of an internal assembly of an exemplary motion duck decoy. FIG. 7A illustrates a sectional view from above; FIG. 7B illustrates a side sectional view of the decoy in a resting position on the surface 792 of water 790; FIG. 7C illustrates a side sectional view of the decoy in a feeding position with the head (710) and breast (706) of the decoy below the surface 792 of the water and the tail 780 elevated above the surface 792 of the water.

The alternative embodiment shown in FIGS. 7A, 7B, and 7C includes a gear track assembly that rotates the decoy into the duck feeding position. Decoy 700 may include a decoy shell (701), a motor (702), which may be centrally anchored, a battery pack (704) to power the motor, a weight (711), a circular gear (703) rotated by an axle (705), and a semicircular gear track (707) positioned within and secured or mounted to the decoy shell (701). The motor, battery pack, and weight may be included in a weighted motor assembly, which may also include circular gear (703). The motor or weighted motor assembly may be mounted to the decoy shell using a swivel or other rotatable mount that allows the decoy shell to rotate relative to the motor or weighted motor assembly. The motor may be actuated or cycled by a receiver (708). In an embodiment, motor (702), battery pack (704), and weight (711) are connected or secured to circular gear (703) and remain substantially stationary or level with respect to the water surface (792). Actuation of the motor causes circular gear (703) to rotate within gear track (707) causing the decoy shell to rotate about the motor, weight, and battery pack into and out of the feeding position. These elements force a dynamic weight shift and induce pivotal body movement from the duck resting position to the duck feeding position. The weight or the combined weight of the components of the weighted motor assembly may ensure that the weight or weighted motor assembly remains stable or substantially stationary as the decoy rotates into the feeding position. An adjustable air gap (709) in the neck facilitates efficient head submersion using one or more ports for water or air (not shown). The feeding motion of the decoy may be altered by reconfiguration, for example changing the location within the shell or with respect to other components and location of elements such as motor (702) placement, receiver (708) positioning, axle (705) adjustment, gear (703) augmentation, pin variation, and track (707). The weight (711) can also be adjusted in size, position, or material to achieve the desired motion.

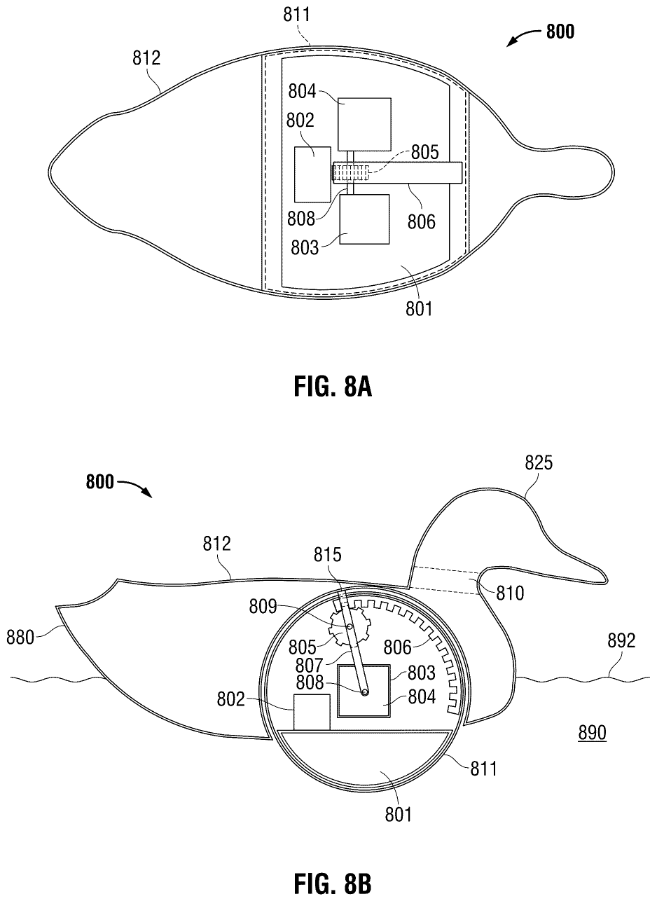

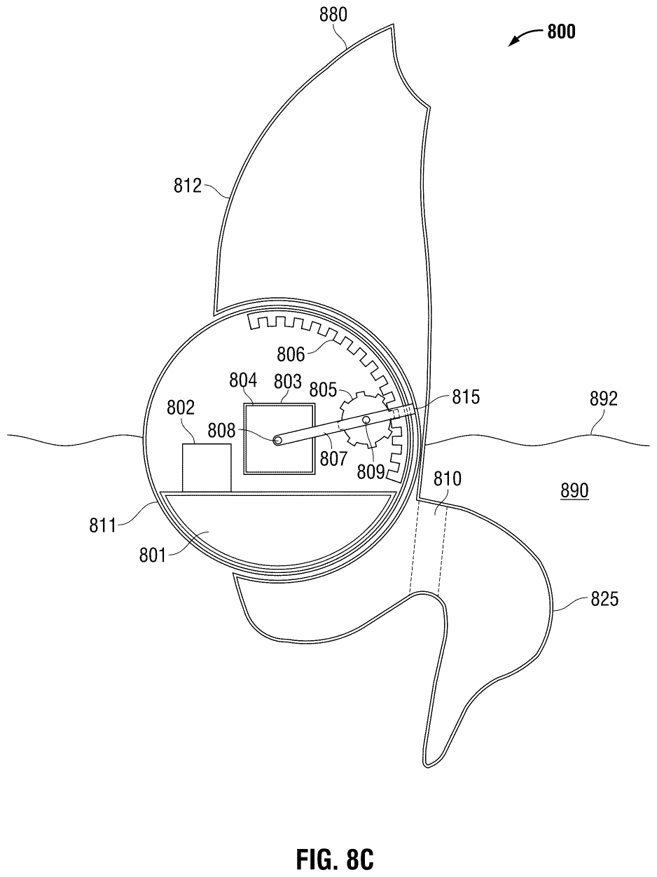

FIGS. 8A, 8B, and 8C illustrate different perspectives of an alternative embodiment of an internal assembly of an exemplary motion duck decoy. FIG. 8A illustrates a sectional view from above; FIG. 8B illustrates a side sectional view of the decoy in a resting position on the surface 892 of water 890; FIG. 8C illustrates a side sectional view of the decoy in a feeding position with the head (825) of the decoy below the surface 892 of the water and the tail 880 elevated above the surface 892 of the water.

The alternative embodiment shown in FIGS. 8A, 8B, and 8C includes a dynamic body (812) rotation mechanism that causes the duck decoy to mimic the duck feeding motion. A static body (811) of decoy 800 houses components, including a weight (801), a receiver (802), a battery pack (803), a motor (804), a gear (805), a gear track (806), a lever arm (807), an axle (808), and a pin (809). The weight, motor, and battery pack may be combined in or form a weighted motor assembly within static body (811). The motor (804), which may be actuated or cycled by receiver (802), imparts rotation to the axle (808), linked to the lever arm (807), thereby driving the gear (805) along a semicircular path, guided by the gear track (806). The gear (805) may be connected to the lever arm (807) by the pin (809). Lever arm (807) may mount, connect or couple static body (811) to dynamic body (812) at mounting point (815). Dynamic rotation of dynamic body (812), connected to the lever arm (807), results in a lifelike feeding motion, with the dynamic body (812) moving around the static body (811), going from a duck resting position to a duck feeding position. Static body (811) may remain substantially stationary in relation to dynamic body (812) as the dynamic body rotates into and out of the duck feeding position. The adjustable air gap (810) facilitates submersion of the decoy's head using one or more ports for air or water (not shown). Components, including the weight (801), battery pack (803), motor (804), axle (808), gear (805), pin (809), and gear track (806), can be adjusted in size, position, or material to achieve the desired motion. A stabilizer or similar device can be added to ensure balance of the static body (811).

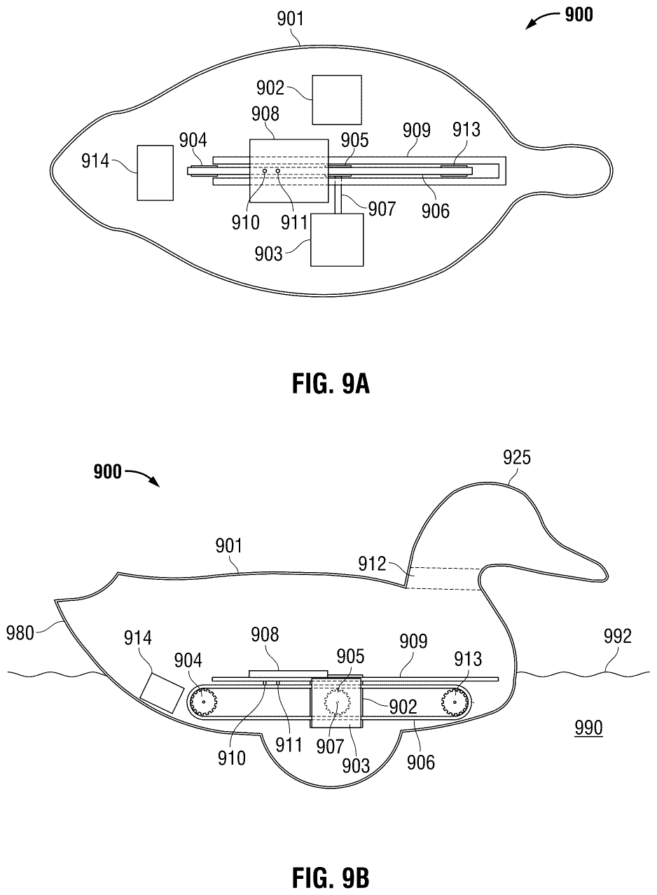

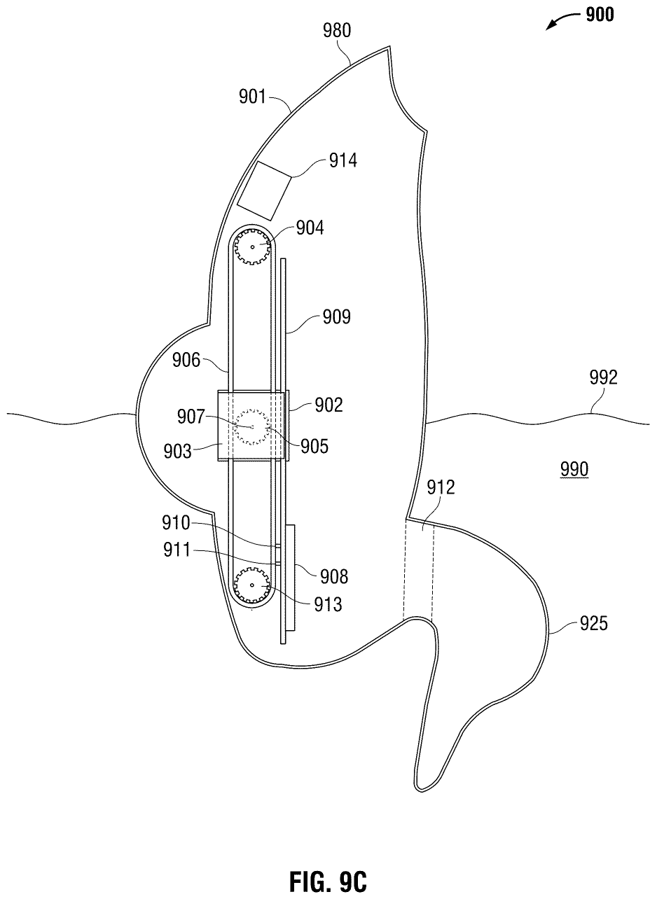

FIGS. 9A, 9B, and 9C illustrate different perspectives of an alternative embodiment of an internal assembly of an exemplary motion duck decoy. FIG. 9A illustrates a sectional view from above; FIG. 9B illustrates a side sectional view of the decoy in a resting position on the surface 992 of water 990; FIG. 9C illustrates a side sectional view of the decoy in a feeding position with the head (925) of the decoy below the surface 992 of the water and the tail 980 elevated above the surface 992 of the water.

The alternative embodiment shown in FIGS. 9A, 9B, and 9C uses a pulley system to achieve a duck decoy feeding motion. The decoy features a shell (901) with lifelike paint and textures, a battery pack (902), and a motor (903) coupled to gear 1(904 ), gear 2 (905) with axle (907), and gear 3 (913 ). A continuous belt (906) establishes a pulley system, orchestrating the movement of a weight (908) connected to the belt by pin 1 (910 ) and pin 2 (911 ) extending through slotted slide (909). The motor (903), cycled or actuated by receiver (914), rotates gear 2 (905 ) which moves the weight (908) and orchestrates a weight shift and induces a pivotal body movement from a duck resting position to a duck feeding position. The positions of gear 1 (904), gear 2 (905 ), and gear 3 (913 ) can be adjusted to regulate the extent of lifelike movements, and variations in the pulley system allow for alternative rotation methods, including addition and subtraction of gears. An air gap (912) within the head region allows water passage using one or more ports for air or water (not shown), aiding in the submersion of the head during the feeding motion. The size, location, and configuration of weight (908), battery pack (902), motor (903), axle (907), gear 1 (904 ), gear 2 (905 ), gear 3 (913 ), pin 1 (910 ), pin 2 (911 ), and gear track (906) can be adjustable as needed for desired motion. In alternative embodiments, belt (906) may be replaced by a chain or a track.

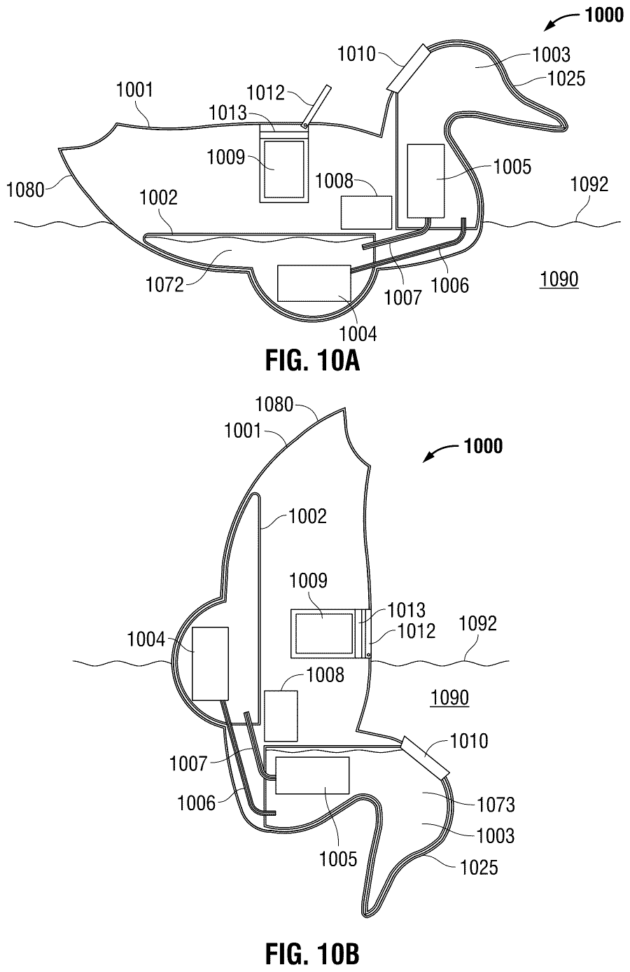

FIGS. 10A and 10B illustrate different perspectives of an alternative embodiment of an internal assembly of an exemplary motion duck decoy. FIG. 10A illustrates a side sectional view of the decoy in a resting position on the surface 1092 of water 1090; FIG. 10B illustrates a side sectional view of the decoy in a feeding position with the head (1025) of the decoy below the surface 1092 of the water and the tail 1080 elevated above the surface 1092 of the water.

The alternative embodiment shown in FIGS. 10A and 10 B uses one or more water pumps to move water between internal chambers to create a duck decoy feeding motion. The decoy features a plastic shell (1001) emulating natural textures, accommodating two chambers: chamber 1 (1002) and chamber 2 (1003). FIG. 10A shows water (1072) in chamber 1 (1002), and FIG. 10B shows water (1073) in chamber 2 (1003). In an embodiment, each chamber integrates a pump—pump 1 (1004) for chamber 1002 and pump 2 (1005) for chamber 1003—designed for directional water flow through interconnected inflow and outflow conduits (1006 and 1007). A feeding motion is induced by the cyclical fluid transfer between Chamber 1 (1002) and Chamber 2 (1003), which causes the decoy to cyclically pivot from a “resting position” to “feeding position” and back. Wireless remote control cycling or actuation of the pumps (1004 and 1005) is facilitated by a receiver (1008), with power derived from a battery pack (1009) accessible through a cap 1 (1010 ). Water enters the chamber system through a cap (1011). The battery pack (1009) can be located inside a chamber, accessible by hatch (1012) and cap 2 (1013 ). The component materials, sizes, and positions can be adjusted to achieve the desired motion. In alternative embodiments the pumps 1004, 1005 can be located within the interior of decoy 1000 but external to chambers 1002, 1003, or can be mounted on the wall of chambers 1002, 1003. In an alternative embodiment, a single pump is used. In another alternative embodiment, the pumps displace water in the chambers with air.

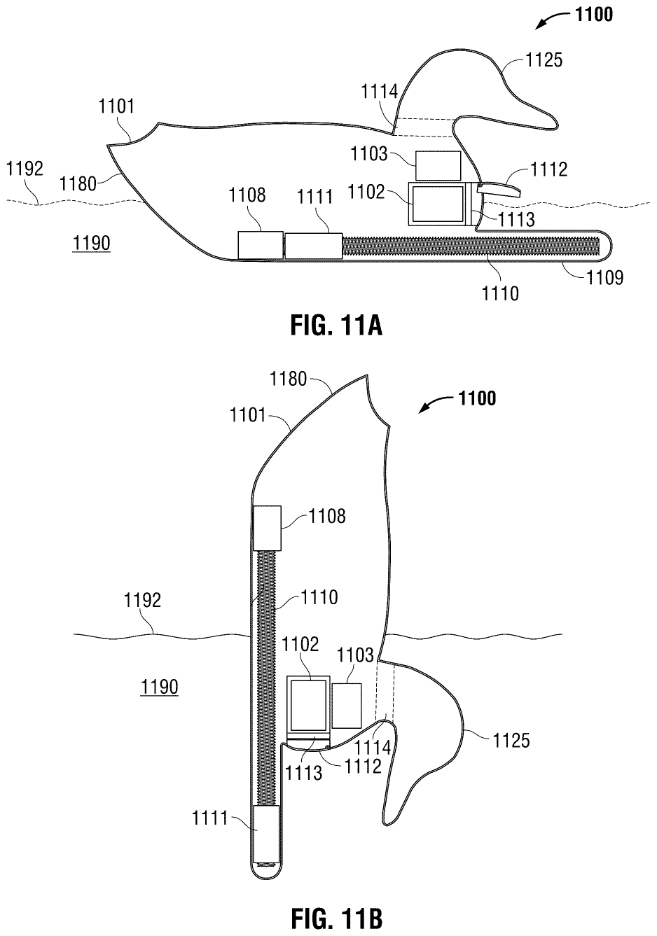

FIGS. 11A and 11B illustrate different perspectives of an alternative embodiment of an internal assembly of an exemplary motion duck decoy. FIG. 11B illustrates a side sectional view of the decoy in a resting position on the surface 1192 of water 1190; FIG. 11B illustrates a side sectional view of the decoy in a feeding position with the head (1125) of the decoy below the surface 1192 of the water and the tail 1180 elevated above the surface 1192 of the water.

The alternative embodiment shown in FIGS. 11A and 11B includes a weight mounted on or coupled or fixed to a ball screw motor to create a duck decoy feeding motion. The duck decoy, taking the form of a detailed plastic shell (1101), accommodates a battery pack (1102) providing power to a ball screw motor (1108). A weight (1111) may be mounted on a threaded shaft or screw (1110), which may be cylindrical. The mounting may include ball bearings or rolling balls (not shown) to enhance or effectuate conversion of the rotational energy of the threaded shaft to linear movement of the weight. The motor regulates the movement of a weight (1111) along threaded shaft (1110) traversing through an adjustable-length bulbous bow (1109). This motion induces cyclic shifts between a lifelike “resting” and “feeding” position, simulating authentic duck behavior. An air gap (1104) within the neck region facilitates water passage for natural head submersion using one or more ports for air or water (not shown). The motion of the ball screw motor (1108) may be driven by the wireless remote's signal to the receiver (1103), cycling or actuating the battery pack (1102) to drive the motor (1108). An air gap (1114) within the head region allows water passage using one or more ports for air or water (not shown), aiding in the submersion of the head during the feeding motion. This embodiment offers versatility in battery pack (1102) and receiver (1103) placement while upholding the essence of the duck decoy's authentic and adjustable simulation of natural duck actions, including the option to adjust the length of the threaded track (1110) and bulbous bow (1109). The battery pack (1102) can be located inside a chamber, accessible by hatch (1112) and cap (1113). Key access points, including waterproof cap (1113) and an access hatch (1112), ease battery pack retrieval while accommodating potential variations in component placement without compromising operational dynamics.

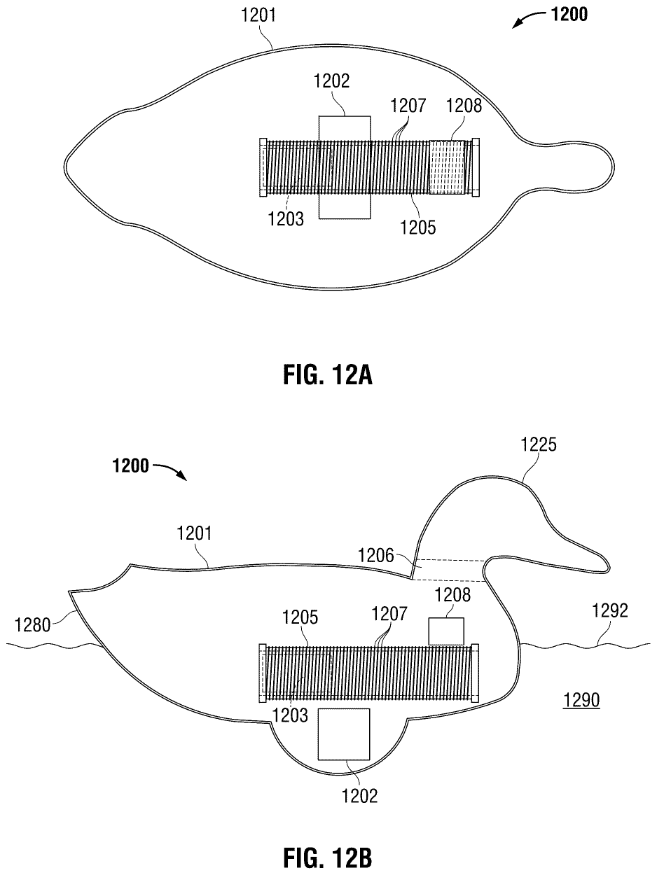

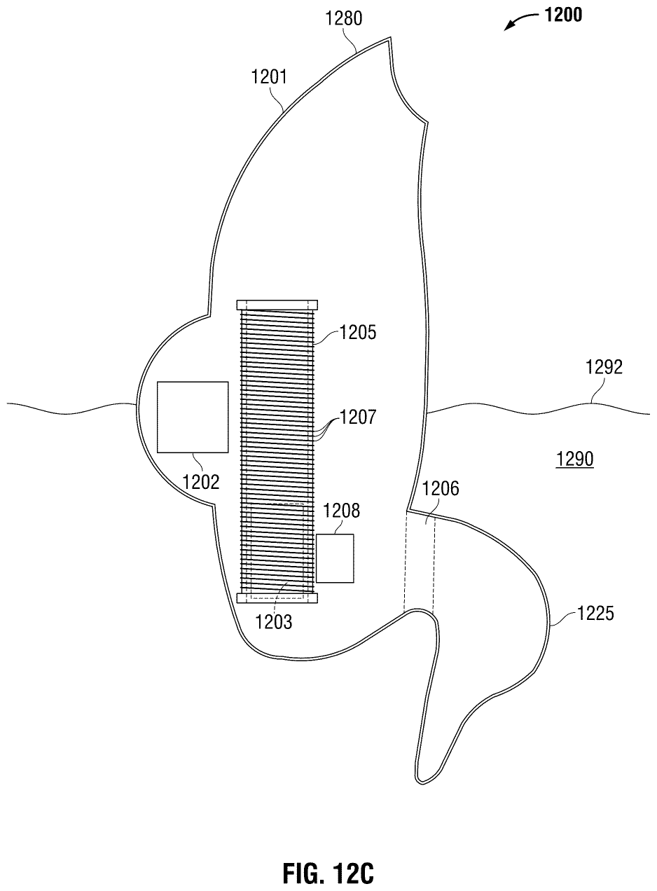

FIGS. 12A, 12B, and 12C illustrate different perspectives of an alternative embodiment of an internal assembly of an exemplary motion duck decoy. FIG. 12A illustrates a sectional view from above; FIG. 12B illustrates a side sectional view of the decoy in a resting position on the surface 1292 of water 1290; FIG. 12C illustrates a side sectional view of the decoy in a feeding position with the head (1225) of the decoy below the surface 1292 of the water and the tail 1280 elevated above the surface 1292 of the water.

The alternative embodiment shown in FIGS. 12A, 12B, and 12C harness the internal motion of a magnet to induce a feeding motion in the duck decoy. Constituent elements comprise a lifelike decoy shell (1201), a battery pack (1202), a cylindrical magnet (1203), a receiver (1204), a cylindrical plastic tube (1205), and an air gap (1206). The magnet (1203) is securely confined within cylindrical tube (1205), which is enveloped by a wire coil (1207), which may include copper wire. Activation of the battery pack (1202) via the receiver (1208) initiates the charging of the wire coil (1207), thereby generating a magnetic field around the plastic tube (1205). This magnetic field precipitates a reciprocating motion of the magnet (1203) within the tube, resulting in a buoyancy shift in the decoy due to the movement and mass of the magnet. The introduction of an adjustable air gap (1206) in the duck's neck facilitates controlled water ingress using one or more ports for air or water (not shown), thereby promoting the submersion of the head during the simulated feeding motion. Dimensional and positional aspects of the magnet (1203), plastic tube (1205), receiver (1208), air gap (1206), and copper wire coil (1207) can be customized to realize the desired feeding motion, and the placement of various components is modifiable to achieve optimal performance.

Paddling duck feet may be added to a duck decoy to add verisimilitude and enhance the appearance of a feeding duck. The feet may be mechanically driven by one ore more motors, including a dual-shaft motor, housed within the decoy body. The motor may drive a transmission that converts rotational motion into oscillating or reciprocating motion, which is transferred to one or more external feet through a sealed opening in the body. In embodiments, the transmission may include gears and linkages (such as a worm gear and offset pins coupled to levers). Alternative embodiments may include other or additional mechanical arrangements capable of transmitting motion from inside the body to external feet. The openings through which the feet extend may be sealed to prevent water ingress while allowing the required motion.

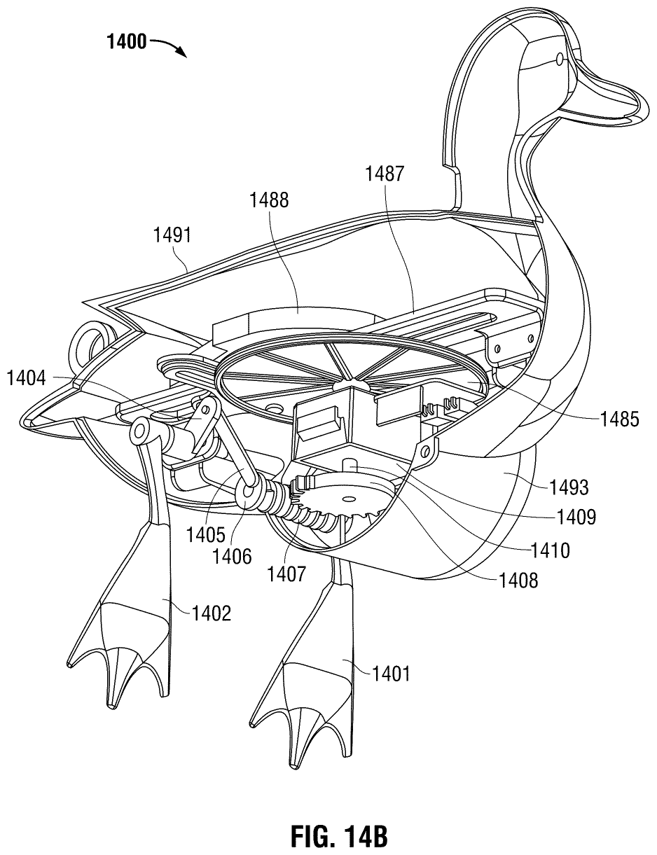

FIGS. 14A and 14B illustrate alternative perspectives of an embodiment of an exemplary motion duck decoy 1400 with paddling duck feet. Decoy 1400 includes a shell 1491 comprising a bottom or underside shell surface 1492 and a rounded shape or protrusion 1493 Rounded shape or protrusion 1493 may be a half-cylinder or partially cylindrical. Disposed within the interior of shell 1491 is an embodiment of a scotch yoke mechanism (including weight 1488, track 1487, and wheel (or disk-shaped crank) 1485) coupled to a dual shaft worm gear motor 1409. Dual shaft worm gear motor 1409 turns gear 1408 that makes contact with worm gear drive 1407, changing the axis of rotation from motor shaft 1410 to worm gear drive 1407. Worm gear drive 1407 transmits the power from motor shaft 1410 to wheel 1406 with offset pin (not shown) coupled to arm 1405. Arm 1405 is coupled to joint 1404, which is coupled to right paddling foot 1402, which extends to the exterior of decoy shell 1491 through opening 1403. Opening 1403 may include a watertight seal and may be slot-shaped. Joint 1404 may be or include a clevis joint. Opening 1403 may be waterproof. In an embodiment, similar corresponding structures transmit power from motor shaft 1410 to left paddling foot 1401, worm gear drive 1407 transmits power from motor shaft 1410 to a wheel (not shown) with offset pin (not shown) similar to wheel 1406, which wheel is coupled to an arm (not shown) similar to arm 1405, which is coupled to a joint (not shown) similar to joint 1404, which is coupled to left paddling foot 1401 that extends to the exterior of decoy shell 1491 through an opening similar to opening 1403 (not shown). In an embodiment, the linkage between paddling feet 1402 and joint 1404, and the similar linkage between paddling foot 1401 and its corresponding joint (not shown) may include one or more bearings or bushings, which in an embodiment may be waterproof.

In an embodiment, the offset pin of wheel 1406 (coupled to right paddling foot 1402 via arm 1405 and joint 1405) is offset relative to the corresponding offset pin (not shown) on the wheel (not shown) coupled to left paddling foot 1401 (via arm and joint), preferably by 180 degrees, so that the rotational force imparted by worm gear drive 1407 causes paddling feet 1401, 1402 to move out of phase with each other. The motion imparted to feet 1401, 1402 is “lifelike” in that it mimics the motion of actual duck legs during feeding. Feet 1401, 1402 may move in a synchronized motion. The synchronized motion of the feet may mimic the motion of duck feet during feeding. In an embodiment, the paddling duck feet may cycle between stationary and paddling. In an embodiment, this effect may be achieved by use of semi-circular gear 1408. In an alternative embodiment this effect may be achieved by cycling motor 1409, or turning drive shaft 1410, intermittently, periodically, or controllably, instead of consistently.

In an embodiment, feet 1401, 1402 may be made of nylon, ABS, polyethylene (e.g., HDPE, LDPE), silicone, thermoplastic elastomer, urethane rubber, neoprene, or similar materials and may be textured or pigmented to symbolize realism.

In some embodiments of a motion duck decoy, the decoy includes a drive system including a motor and a weight (or weight-bearing carriage) coupled to a drive coupling that transmits and translates motor-driven rotational motion to motion of the weight, which may be linear. In some embodiments, the drive coupling may comprise rigid drive elements. For example, the weight (or a weight-bearing carriage) may be attached, fixed, or directly coupled to a gear-driven pulley or similar mechanism coupled to a motor shaft. In alternative embodiments, the drive coupling may also include a flexible drive element (for example, a chain, belt or other looped or articulated element), that may be driven by a gear-driven pulley or sprocket coupled to the motor. The weight (or weight-bearing carriage) may be coupled to the flexible drive element. The coupling to the flexible drive element may be loose or indirect, and may include a coupling feature (for example, a follower, pusher, pin or other coupling element) that engages the weight (or weight-bearing carriage) along a defined path. The coupling feature may be attached or affixed to the flexible drive element but not attached or affixed to the weight or weight-bearing carriage. The weight (or weight-bearing carriage) may be detachably coupled to the flexible drive element.

In an exemplary alternative embodiment, the drive system includes a motor mounted within the decoy body and coupled to a flexible drive element that circulates or reciprocates along an internal path. The flexible drive element may be arranged as a loop supported by multiple guide members (e.g., sprockets, pulleys, or guides) such that operation of the motor causes the flexible drive element to move continuously or intermittently. A coupling feature may be attached to, fixed to, or formed as part of, the flexible drive element and positioned to mechanically engage a movable internal weight (or weight-bearing carriage). In one example, the coupling feature comprises a protrusion, rod, pin, or follower that extends from the flexible drive element and interfaces with a recess, slot, or channel formed in the weight (or weight-bearing carriage). As the flexible drive element moves or rotates, the coupling feature contacts the weight and translates it along a constrained path within the body without the weight being attached to or fixed to the flexible drive element. The weight may be guided by rails, grooves, or internal surfaces of the body to ensure controlled motion. Movement of the weight shifts the center of gravity of the decoy, causing the decoy body to rotate, rock, or pitch to simulate feeding or other lifelike motion. Other configurations of the flexible drive element, coupling feature, and guide structure also may be used without departing from the spirit or scope of the invention.

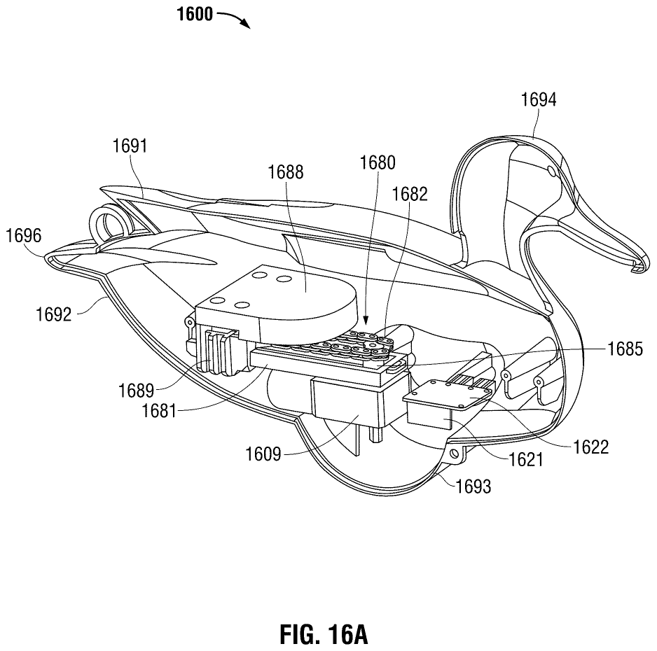

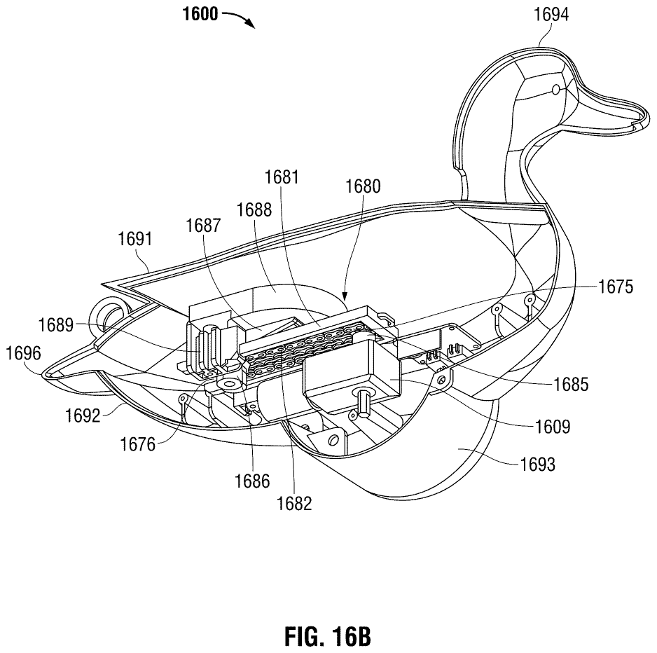

FIGS. 16A and 16B illustrate alternative perspectives of an internal assembly of an alternative embodiment of an exemplary motion duck decoy 1600. Decoy 1600 includes a shell 1691 comprising tail section 1696, bottom or underside shell surface 1692, a rounded shape or protrusion 1693 (which may be a half-cylinder or partially cylindrical), and head section 1694. Drive system 1680 disposed within the interior of shell 1691 includes dual-shaft motor 1609, sprocket 1685, chain 1682, and pulley 1686. In an alternative embodiment, motor 1609 may be a single-shaft motor. In an embodiment, chain 1682 is coupled at a first end 1675 to sprocket 1685 and at a second end 1676 to pulley 1686. Chain 1682 may be linearly aligned with a longitudinal axis of decoy 1600. First end 1675 and second end 1676 may be linearly aligned with a longitudinal axis of decoy 1600. Sprocket 1685 and/or pulley 1686 may include cogs (not shown) configured to engage links of chain 1682. Pulley 1686 may be an idler pulley. Chain 1682 may be a bicycle chain. Sprocket 1685 is coupled to a drive shaft (not shown) of motor 1609 so that rotating the drive shaft rotates sprocket 1685 and causes chain 1682 to cycle around sprocket 1685 and pulley 1686. In an embodiment, a timing belt and timing belt pulley or sprocket may be used instead of chain 1682 and sprocket 1685.

Pulley 1686 may be mounted to or on a pulley mounting element (not shown) affixed to the interior of decoy shell 1691. The pulley mounting element may include a post, axle, or similar mounting structure, and may include one or more bearings or bushings.

Weight 1688 may be mounted on carriage 1689 and support bracket 1687 affixed to carriage 1689. In an embodiment, weight 1688 may be coupled to chain 1682. The coupling between weight 1688 and chain 1682 may include a pin (not shown) mounted on a link of chain 1682 that fits into a slot (not shown) in a chain-facing surface of weight 1688. The slot may be linear. The slot may be linear and oriented orthogonally to a longitudinal axis of decoy 1600. In an alternative embodiment, carriage 1689 may be coupled to chain 1682, and the coupling may include a pin (not shown) that fits into a chain-facing surface of carriage 1689. Rotational motion of chain 1682 around sprocket 1685 and pulley 1686 causes weight 1688 to move linearly in alignment with chain 1682. The pin slides within the slot so that weight 1688 moves freely with pin and chain and remains aligned with chain 1682.

In an embodiment, decoy 1600 may include a rail 1681. Rail 1681 may be affixed to or mounted on the interior of decoy shell 1691 and interposed between chain 1682 and motor 1609 and include slots or apertures to accommodate sprocket 1685 and/or pulley 1686. Carriage 1689 may move linearly along rail 1681. Pulley 1686 may be mounted on or to rail 1681. In an embodiment, carriage 1689 is a captive carriage with portions of the carriage overlapping the sides of rail 1681 to retain the carriage on the rail while allowing smooth linear movement and preventing lateral or vertical displacement of the carriage. Carriage 1689 may include a flange configured to slide along a guiding structure of rail 1681.

In an embodiment, weight 1688 moves linearly along a longitudinal axis of decoy 1500 such that when weight 1688 is cycled towards head section 1694 it moves the center of gravity of decoy 1600 forward, thereby causing a forward part of decoy 1600 to rotate into the water, and tail section 1696 and underside shell surface 1692 to rotate into the air, thereby mimicking the feeding motion of a duck. The forward part of the decoy that rotates into the water may include all or part of head section 1694. The decoy may rotate around rounded shape or protuberance 1693.

Drive system 1680 further includes a power supply (not shown) disposed in power supply compartment or housing 1621 and a printed circuit board 1622 housing control circuitry and components for controlling motor 1609 and communications circuitry and components for maintaining a communications link with a remote controller or other motion duck decoys. The power supply may include one or more batteries and/or a battery pack.

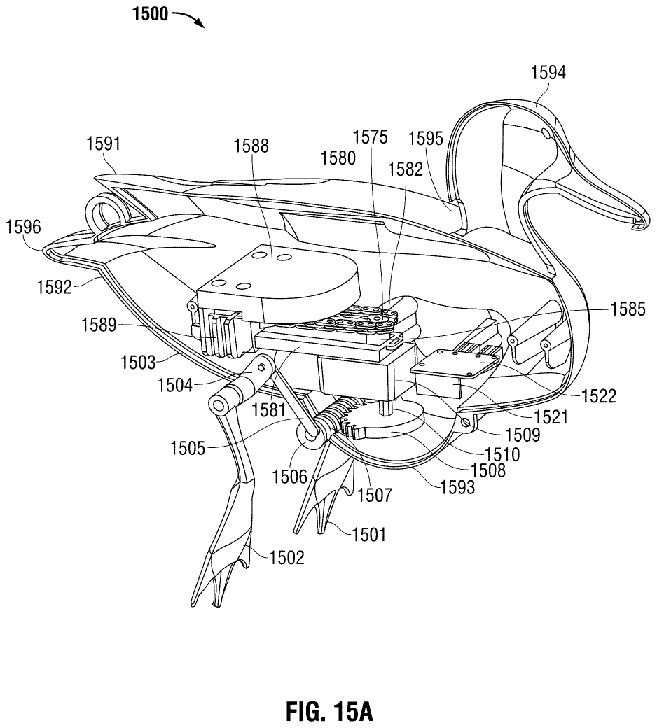

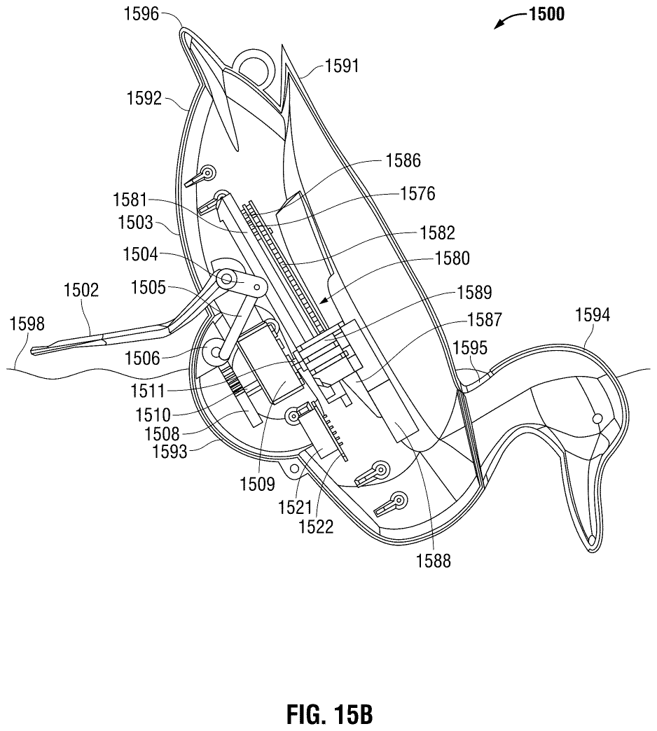

FIGS. 15A and 15B illustrate sectional views of an alternative embodiment of an exemplary motion duck decoy 1500 with paddling duck feet. Decoy 1500 includes a shell 1591 comprising tail section 1596, bottom or underside shell surface 1592, a rounded shape 1593, air port notch 1595, and head section 1594. Decoy 1500 includes left paddling foot 1501 and right paddling foot 1502. Left and right paddling feet may protrude through watertight openings in underside shell surface 1592 (not shown). Drive system 1580 disposed within the interior of shell 1591 includes dual shaft motor 1509, sprocket 1585, and chain 1582. Motor 1509 may be a dual shaft worm gear motor. In an embodiment, chain 1582 is coupled at a first end 1575 to sprocket 1585 and at a second end 1576 to a pulley 1586. Chain 1582 may be linearly aligned with a longitudinal axis of decoy 1500. Sprocket 1585 may include cogs (not shown) configured to engage links of chain 1582. Chain 1582 may be a bicycle chain. Sprocket 1585 may be coupled to a first drive shaft 1511 of motor 1509 so that rotating drive shaft 1511 rotates sprocket 1585 and causes chain 1582 to cycle or rotate around sprocket 1585 at first end 1575 and pulley 1586 at second end 1576. In an embodiment, a timing belt and timing belt pulley or sprocket may be used instead of chain 1582 and sprocket 1585.

Pulley 1586 may be mounted to or on a pulley mounting element (not shown) affixed to the interior of decoy shell 1591. The pulley mounting element may include a post, axle, or similar mounting structure, and may include one or more bearings or bushings. Weight 1588 may be mounted on carriage 1589 and support bracket 1587 affixed to carriage 1589. In an embodiment, weight 1588 may be coupled to chain 1582. The coupling between weight 1588 and chain 1582 may include a pin (not shown) mounted on a link of chain 1582 that fits into a slot (not shown) in a chain-facing surface of weight 1588. The slot may be linear. The slot may be linear and oriented orthogonally to a longitudinal axis of decoy 1500. In an alternative embodiment, carriage 1589 may be coupled to chain 1582, and the coupling may include a pin (not shown) that fits into a chain-facing surface of carriage 1589. Rotational motion of chain 1582 around sprocket 1585 and pulley 1586 causes weight 1588 to move linearly in alignment with chain 1582. The pin slides within the slot so that weight 1588 moves freely with pin and chain and remains aligned with chain 1582.

In an embodiment, rail 1581 is affixed to the interior of decoy shell 1591. Rail 1581 may be interposed between chain 1582 and motor 1509 and include a slot or aperture (not shown) to accommodate drive shaft 1511 or sprocket 1585. Rail 1581 may include a slot or aperture (not shown) to accommodate a pulley mounting element for pulley 1586. Pulley 1586 may be mounted to rail 1581. Carriage 1589 may move linearly along rail 1581. In an embodiment, carriage 1589 is a captive carriage with portions of the carriage overlapping the sides of the rail to retain the carriage on the rail while allowing smooth axial movement and preventing lateral or vertical displacement of the carriage. Carriage 1589 may include a flange configured to slide along a guiding structure of rail 1581.

In an embodiment, weight 1588 moves linearly along a longitudinal axis of decoy 1500 such that when weight 1588 is cycled towards head section 1594 it moves the center of gravity of decoy 1500 forward, thereby causing a forward part of decoy 1500 to rotate into water 1598 (as shown in FIG. 15B), and causing tail section 1596, underside shell surface 1592, and left and right paddling feet 1501, 1502, to rotate into the air, thereby mimicking the feeding motion of a duck. The forward part of the decoy that rotates into water 1598 may include all or part of head section 1594. The decoy may rotate around rounded shape or protuberance 1593.

In an embodiment, dual shaft worm gear motor 1509 turns gear 1508 that makes contact with worm gear drive 1507, changing the axis of rotation from motor shaft 1510 to worm gear drive 1507. Worm gear drive 1507 transmits the power from second motor shaft 1510 to wheel 1506 with offset pin (not shown) coupled to arm 1505. Arm 1505 is coupled to joint 1504, which is coupled to right paddling foot 1502 that extends to the exterior of decoy shell 1591 through an opening (not shown), which may be waterproof. Joint 1504 may be or include a clevis joint. In an alternative embodiment, different single-shaft motors drive sprocket 1585 and worm gear 1508. The linkage between paddling feet 1502 and joint 1504, and the similar linkage between paddling foot 1501 and its corresponding joint (not shown), may include one or more bearings or bushings, which in an embodiment may be waterproof.

In an embodiment, similar corresponding structures transmit power from motor shaft 1510 to worm gear drive 1507 to a wheel with offset pin (not shown) coupled to an arm and joint (not shown) coupled to left paddling foot 1501 that extends to the exterior of decoy shell 1591. In an embodiment, the offset pin of wheel 1506 (coupled to right paddling foot 1502 via arm 1505 and joint 1505) is offset relative to the corresponding offset pin (not shown) of the wheel coupled to left paddling foot 1501 (via arm and joint), preferably by 180 degrees, so that the rotational force imparted by worm gear drive 1507 causes paddling feet 1501, 1502 to move out of phase with each other.

In an embodiment, when movement of weight 1588 moves the center of gravity of decoy 1500 forward, tail section 1596, underside shell surface 1592, and left and right paddling feet 1501, 1502 are rotated into the air, thereby mimicking the feeding motion of a duck. In an embodiment, when left and right paddling feet 1501, 1502 are rotated into the air, the motion imparted by motor 1509 to feet 1501, 1502 is “lifelike” in that it mimics the motion of actual duck legs during feeding. Feet 1501, 1502 may move in a synchronized motion. The synchronized motion of the feet may mimic the motion of duck feet during feeding. In an embodiment, the paddling duck feet cycle between stationary and paddling. In an embodiment, this effect may be achieved by use of semi-circular gear 1508. In an alternative embodiment this effect may be achieved by cycling motor 1509, or turning drive shaft 1510, intermittently, periodically, or controllably, instead of consistently.

Drive system 1580 further includes a power supply (not shown) disposed in power supply compartment or housing 1521 and a printed circuit board 1522 housing control circuitry and components for controlling motor 1509 and communications circuitry and components for maintaining a communications link with a remote controller or other motion duck decoys. In embodiments with a dual-shaft motor, the first and second drives shafts may be controlled and operated independently of the other.

Embodiments in which the weight is mounted directly or indirectly to a chain or belt, as shown in FIGS. 16A, 16B, 15A, and 15B, have several advantages over the Scotch yoke mechanism. The mechanism is more robust with fewer points of failure. There are more ways to internally configure the mechanism within the decoy shell. Manufacturing costs are reduced. With two controllable motor drive shafts, the feeding motion and paddling fee motion can have different action cycles.

The embodiments of a motion duck decoy described herein are more lifelike in comparison to other decoys; they create disruptions on the water's surface, mimic the appearance of a living duck, and incorporate the battery, motor and weight into and inside of a self-contained decoy.

Embodiments are intended to be used in waterfowl hunting and conservation practices to attract living ducks and other waterfowl. Suitable for any open body of water-ponds, lakes, coastline, marsh, flooded timber - embodiments of the motion duck decoy may be placed either alone or amongst other motion and static decoys in a spread to draw the attention of living ducks. An exemplary application would be when duck hunting on a lake. Embodiments may be used with other decoys, for example, a spinning wing decoy and two dozen static decoys, to add a life like motion to the decoy spread.

The advantages of the embodiments described herein include easy deployment, lifelike feeding motion, easy operation, and realistic appearance. Because the weight, and battery pack are contained within the decoy, deployment is very simple. The advantage of the feeding motion is the duck head and body of the decoy, and in embodiments the paddling feet, move in a similar fashion to that of a living duck. Lifelike textures and paint colors may be used to realistically mimic the appearance of a live feeding duck.

In an embodiment, a duck decoy creates the feeding motion of a duck with the weight, battery pack, and motor mechanism all enclosed in the decoy (one unit).

In an embodiment, a duck decoy utilizes an internal Scotch yoke motor mechanism to mimic the feeding motion of a duck.

In an embodiment, a full body motion duck decoy mimics the tail-up feeding motion of a living duck, with the battery, motor, and weight all internally housed inside the decoy.

In an embodiment, a duck decoy mimics the tail-up feeding motion of a living duck using a creatively designed shell geometry and motor-powered internal mass-movement.

Other solutions do not effectively or realistically mimic the natural and realistic tail-up feeding motion of living ducks.

In an embodiment, a duck decoy uses a full body shell design that is optimally configured to create the tail-up feeding motion between the resting and feeding position with the battery, motor, and weight internally housed.

In an embodiment of a motion duck decoy includes a mechanical assembly and means for moving the assembly within the decoy to cause two external feet to move in a synchronized paddling motion to further mimic the feeding motion of a duck. In an embodiment, the mechanical assembly is powered by a motor, and in an alternative embodiment, the mechanical assembly is powered by the same motor that powers a scotch yoke mechanism or other mechanism that moves the weight within the body of the decoy.

Although embodiments of the present invention have been described in detail, it will be apparent to those skilled in the art that many embodiments taking a variety of specific forms and reflecting changes, substitutions and alterations can be made without departing from the spirit and scope of the inventions disclosed herein. The described embodiments illustrate the scope of the claims but do not restrict the scope of the claims.

What is claimed is:

1. A motion duck decoy, comprising:
a duck decoy comprising a weight and a power source enclosed within the duck decoy, whereby powered motion of the weight within the duck decoy causes the duck decoy to mimic the feeding motion of a duck, wherein causing the duck decoy to mimic the feeding motion of a duck comprises causing the duck decoy to change position from a resting duck position to a duck feeding position and revealing one or more duck feet on the underside of the decoy.

2. The motion duck decoy of claim 1, wherein the duck decoy comprises a duck head and a duck tail section, and in the resting duck position the duck decoy floats on a surface of water with the duck head out of water, and in the duck feeding position, the duck head is submerged and the duck tail section is elevated above the surface of the water.

3. The motion duck decoy of claim 1, wherein causing the duck decoy to mimic the feeding motion of a duck further comprises cycling the duck decoy between the resting duck position and the duck feeding position.

4. The motion duck decoy of claim 1, wherein elevating the duck tail section above the surface of the water in the duck feeding position comprises revealing a light-colored area of the underside of the decoy.

5. The motion duck decoy of claim 4, wherein the duck decoy comprises a shell comprising a top shell surface, said top shell surface having top shell coloration and markings, and an underside shell surface, said underside shell surface having underside coloration, and wherein the underside coloration comprises lighter colors that contrast with the top shell coloration and markings and that reveal a visual flash when the duck decoy changes position to the duck feeding position.

6. The motion duck decoy of claim 5, wherein the duck decoy further comprises a duck head and a duck tail section, the duck tail section comprising an duck tail underside surface comprising the underside coloration, and in the resting position the duck decoy floats on a surface of water with the duck head out of water, and in the duck feeding position, the duck head is submerged and the duck tail section are elevated above the surface of the water,

7. The motion duck decoy of claim 1, wherein the duck decoy further comprises a decoy shell, the shell including an underside shell surface having a rounded shape comprising the form of a half-cylinder, whereby the rounded shape assists rotation of the duck decoy from the resting duck position to the duck feeding position.

8. The motion duck decoy of claim 1, wherein the duck decoy further comprises a motor enclosed within the decoy.

9. The motion duck decoy of claim 8, further comprising a pulley system comprising a gear-driven pulley coupled to the motor and the weight, the pulley system being adapted and configured to move the weight within the decoy.

10. The motion duck decoy of claim 8, further comprising a wireless communications receiver adapted and configured to receive control instructions from a remote controller.

11. The motion duck decoy of claim 1, further comprising a tube enveloped by a wire coil electrically coupled to the power source, wherein the weight comprises a magnet disposed within the tube, wherein applying power to the wire coil causes the weight to move within the decoy.

12. The motion duck decoy of claim 1, wherein the decoy further comprises a first water chamber and a second water chamber and one or more water pumps powered by the power source and adapted and configured to pump water between the first water chamber and the second water chamber, wherein the weight comprises water, and pumping water from the first water chamber to the second water chamber causes the duck decoy to mimic the feeding motion of a duck.

13. The motion duck decoy of claim 8, further comprising dynamic decoy shell coupled to at least one element of a weighted motor assembly comprising the weight, power source, and motor, wherein applying power to the motor causes the dynamic decoy shell to rotate between a resting duck position and a duck feeding position, wherein the weighted motor assembly is housed within a static body of the duck decoy and remains substantially stationary while the dynamic decoy shell rotates between a resting duck position and a duck feeding position.

14. The motion duck decoy of claim 1, wherein powered motion within the duck decoy causes two duck feet to move relative to the underside of the decoy.

15. The motion duck decoy of claim 14, wherein powered motion within the duck decoy causes the two lifelike duck feet to move in a paddling motion.

16. The motion duck decoy of claim 15, wherein a motor enclosed within the decoy provides the powered motion of the weight and the powered motion causing the two duck feet to move in a paddling motion.

17. The motion duck decoy of claim 1, wherein the one or more duck feet cycle from stationary to moving.

18. A motion decoy comprising:
a decoy body;
a movable mass disposed within the decoy body; and
a drive system including a motor and a drive coupling configured to impart movement to the movable mass along a defined path within the decoy body, wherein movement of the movable mass alters a center of gravity of the decoy body to produce lifelike motion of the motion decoy.

19. The motion decoy of claim 18, wherein the drive coupling comprises a flexible drive element.

20. The motion decoy of claim 18, wherein the movable mass is not attached to or fixed to the drive coupling.
